(19) United States
(12) Patent Application Publication
(10) Pub. No.: US 2013/0200682 A1
(43) Pub. Date: Aug. 8, 2013

(54) POWER WASH AND OVERSPRAY WHEEL PROTECTOR

(71) Applicant: Stephan Waldt, Durham, NC (US)

(72) Inventor: Stephan Waldt, Durham, NC (US)

(21) Appl. No.: 13/826,054

(22) Filed: Mar. 14, 2013

Related U.S. Application Data
(63) Continuation-in-part of application No. 13/460,339, filed on Apr. 30, 2012.
(60) Provisional application No. 61/479,975, filed on Apr. 28, 2011.

(51) Int. Cl. B60B 30/06

(52) U.S. Cl. CPC B60B 30/06
USPC 301/37.104; 29/460

(57) ABSTRACT

A power wash and overspray wheel protector is disclosed. According to one aspect, an overspray wheel protector is composed of a member having at least one hand hold opening and a plurality of indicia disposed on at least one surface of the member, where the plurality of indicia comprise a plurality of circular arcs that represent a plurality of radii for allowing a user to remove a first portion of the member such that the remainder of the member comprises a wheel protector having a first portion for protecting a wheel of a first radius and a second portion for protecting a wheel of a second radius.

### PRIORITY CLAIM

This application is a continuation-in-part of U.S. patent application Ser. No. 13/460,339, filed Apr. 30, 2012, which claims the benefit of U.S. Provisional Patent Application Ser. No. 61/479,975, filed Apr. 28, 2011; the disclosures of which are incorporated herein by reference in their entireties.

### TECHNICAL FIELD

The subject matter described herein relates to devices for aiding the cleaning or treatment of vehicle tires. More particularly, the subject matter described herein relates to a power wash and overspray wheel protector.

### BACKGROUND

Vehicle tires, such as automotive or truck tires, are typically made of vulcanized rubber and are mounted onto a metal wheel. Colloquially, however, the term “wheel” is sometimes used to refer to the combination of wheel and tire, and the terms “rim” and “tire rim” are sometimes used to refer to the wheel only, i.e., without the tire. As used herein, the term wheel is used according to its technical definition, i.e., the structure around which the tire is mounted, not including the tire.

During operation, tires are usually exposed to the environment and may suffer damage due to such exposure, reducing the life of the tires. Tire maintenance may include washing the tire or applying a tire cleaner, protectant, or coating to the surface of the tire itself. Popular tire treatment products include protective coatings that include silicone in the chemical formula, and are often sold in a form which is applied to the tire by spraying the product onto the tire rather than applying the product with cloth, brush, or sponge.

One problem with tire protection products that include silicone is that silicone itself is very slippery and at the same time difficult to remove from the surface once applied. When a silicone based tire protectant is sprayed onto a vehicle tire, the person applying the product may accidently spray the product onto the wheel, where it may end up on vehicle brake surfaces, such as the rotor or pads of disk brakes or the drum and pads of drum brakes. When silicone is applied to brake surfaces, the silicone greatly reduces the coefficient of friction on those surfaces, which renders the brakes partially or even completely useless, with potentially disastrous effects.

In addition, the relatively exposed nature of vehicle brake surfaces means that there is little or no protection from contact with water, detergent, or wax while the tire is being washed. This is particularly true when the tire is being subject to a high-pressure power wash, where the high-pressure stream may damage wheel or brake components or move them out of place or out of alignment.

Accordingly, there exists a need for a product that can help protect a wheel from overspray during application of tire products, as well as protect a wheel from exposure to water, detergent, or waxes, during a wash or power wash. More specifically, there exists a need for a power wash and overspray wheel protector.

### SUMMARY

According to one aspect, an overspray wheel protector is composed of a member having at least one hand hold opening and a set of indicia disposed on at least one surface of the member, where the set of indicia comprise a set of circular arcs that represent a set of radii for allowing a user to remove a first portion of the member such that the remainder of the member comprises a wheel protector having a first portion for protecting a wheel of a first radius and a second portion for protecting a wheel of a second radius.

According to another aspect, a method for protecting a wheel from overspray during treatment of a tire or vehicle associated with the wheel includes positioning over the wheel a wheel protector comprising a member having at least one hand hold opening and a set of indicia disposed on at least one surface of the member and representing a set of radii for allowing a user to remove a first portion of the member such that the remainder of the member comprises a wheel protector having a first portion for protecting a wheel of a first radius and a second portion for protecting a wheel of a second radius, the member configured to at least one desired diameter. The tire attached to the wheel or a vehicle to which the wheel is connected is treated, during which the member protects the wheel from overspray.

### BRIEF DESCRIPTION OF THE DRAWINGS

Preferred embodiments of the subject matter described herein will now be explained with reference to the accompanying drawings, where like reference numerals represent like parts, of which:

FIG. 1 is a plan view of a wheel protector, according to an embodiment of the subject matter described herein, showing a set of concentric, staggered, semicircular indicators, perforations, or tear-away tabs for configuring the wheel protector to have a first portion with for protecting wheels of one radius and a second portion for protecting wheels of another radius;

FIG. 2 is a detail view of a portion of the wheel protector of FIG. 1;

FIG. 3 is a perspective view of a wheel protector according to an embodiment of the subject matter described herein showing the separation along some of the indicators, perforations, or tear-away tabs to produce a wheel protector having a first portion for protecting wheels of one radius and a second portion for protecting wheels of another radius;

FIG. 4 is a plan view of a wheel protector according to another embodiment of the subject matter described herein, showing the two radii can be very different;

FIG. 5 is a plan view of a wheel protector according to yet another embodiment of the subject matter described herein, which can be configured to protect wheels of three different radii;

FIG. 6 illustrates a wheel protector according to an embodiment of the subject matter described herein being placed in position for use;

FIG. 7 is a flow chart illustrating an exemplary method for protecting a wheel from overspray during treatment of a tire or vehicle associated with that wheel according to an embodiment of the subject matter described herein;

FIG. 8 is a plan view of a wheel protector according to yet another embodiment of the subject matter described herein, showing a variety of radii ranging from 15½ inches to 23½ inches; and

FIG. 9 is a plan view of a wheel protector according to yet another embodiment of the subject matter described herein, showing a variety of diameters ranging from 15½ inches to 23½ inches.

### DETAILED DESCRIPTION

In accordance with the subject matter disclosed herein, a power wash and overspray wheel protector is disclosed. Reference will now be made in detail to exemplary embodiments of the present invention, examples of which are illustrated in the accompanying drawings. Wherever possible, the same reference numbers will be used throughout the drawings to refer to the same or like parts.

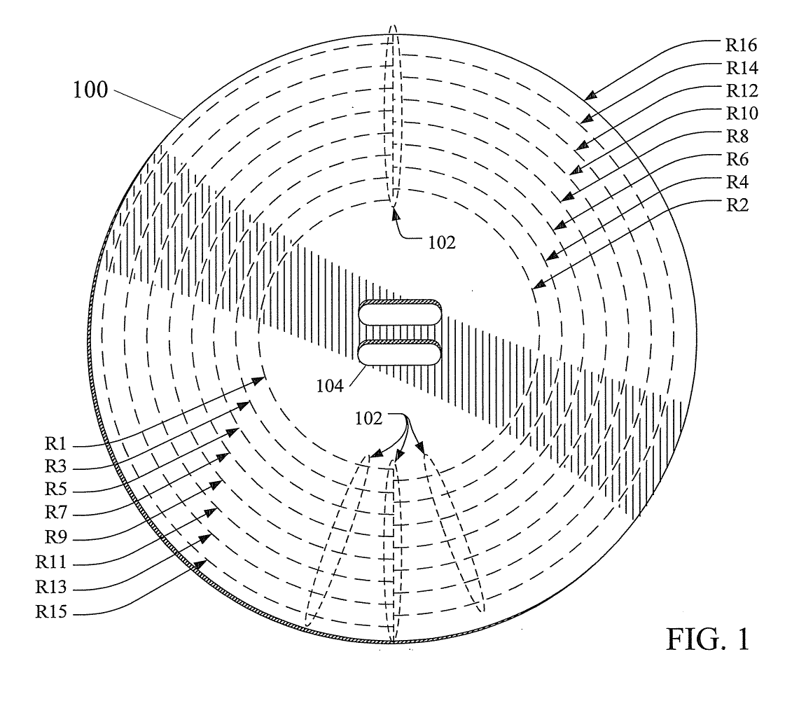

FIG. 1 is a top schematic view of a wheel protector, herein referred to as shield 100, according to an embodiment of the subject matter described herein, showing a set of indicia disposed on at least one surface of the member, where the set of indicia include a number of circular arcs that represent a plurality of radii for allowing a user to remove a first portion of the member such that the remainder of the member is a wheel protector having a first portion for protecting a wheel of a first radius and a second portion for protecting a wheel of a second radius. In one embodiment, shield 100 may be planar or essentially planar. In one embodiment, shield 100 may be fabricated from plastic, such as 4 mil thick corrugated plastic. In other embodiments, shield 100 may be fabricated from foam board, plastic coated foam board, metal or metallic material, cardboard, coated cardboard, wood, composite, or other suitable materials. Shield 100 may be made of material which is water proof or water-resistant. Shield 100 may be made of a rigid material or a semi-rigid material. For example, shield 100 may be made of a material that is rigid enough to withstand a high-pressure stream of liquid, and/or flexible enough to allow shield 100 to be flexed slightly to secure it within the inner diameter of a wheel rim. In one embodiment, shield 100 may be comprised of a material which is flexible enough to be folded or of a less flexible material that includes a seam or fold line for that purpose. Alternatively, shield 100 may be comprised of a material that may be rolled up or curled. The ability to fold or roll shield 100 allows for easy storage of the device.

In one embodiment, shield 100 may be provided in a single sheet that may be sized by the user to the needed diameter. In one embodiment, shield 100 may be marked with sets of indicators 102, such as a set of circular arcs of various radii indicating common rim sizes. These indicators may be printed onto the surface of shield 100 to aid in cutting. In the embodiment illustrated in FIG. 1, for example, the shield 100 includes semicircular lines having various radii marked R1 through R15, with R16 being the radius of the shield itself. In the embodiment illustrated in FIG. 1, shield 100 includes indicators that represent 16 different radii, but other numbers of radii are contemplated.

In an alternate embodiment, the user may be provided with a set of shields, where each shield in the set had semicircular indicators, cuts, or perforations corresponding to a set of radii. For example, a first shield in the set may have perforations that allow the shield to be easily sized from 8 to 15 inches in increments of half of an inch, while a second shield in the set may have perforations that allow the shield to be easily sized from 15 to 31 inches in increments of an inch. Other combinations of sizes, size increments, and number of shields in the set may also be used.

Alternatively, indicators 102 shown on shield 100 may indicate the locations of perforations through the thickness of the sheet that allow the user to cut, tear, or otherwise separate outer portions of shield 100 to leave an inner portion of shield 100 that has at least one desired radius. In these embodiments, indicators 102 may indicate places where shield 100 has been pre-cut, pre-punched, or pre-perforated to form semicircular portions of material that are attached to the rest of the material at a number of places, e.g., connections distributed equally around the circumference of shield 100. In one embodiment, indicators 102 may be tabs holding portions of different radii together and that make it easy for the user to pull apart to obtain a shield of the desired radius or radii. In one embodiment, indicators 102 may be perforated holes through shield 100 allowing the user to easily cut or tear shield 100 at the needed radius. In one embodiment, shield 100 (or the inner-most shield if the desired size shield may be separated from a single sheet) may also include cutouts 104 near the center of shield 100 for the user to hold while placing the shield against the tire rim.

In one embodiment, shield 100 may be essentially disk-shaped, and may have a smooth circumference, but other shapes may be used, including circles, ovals, polygons, regular or irregular shapes, stars, spirals, and so on.

In one embodiment, shield 100 consists of a series of nested concentric indicators that have smooth or substantially smooth perimeters, as shown in FIG. 1, but in alternative embodiments, one or more of the indicators may have a perimeter having variations in radius from the center of the respective indicator.

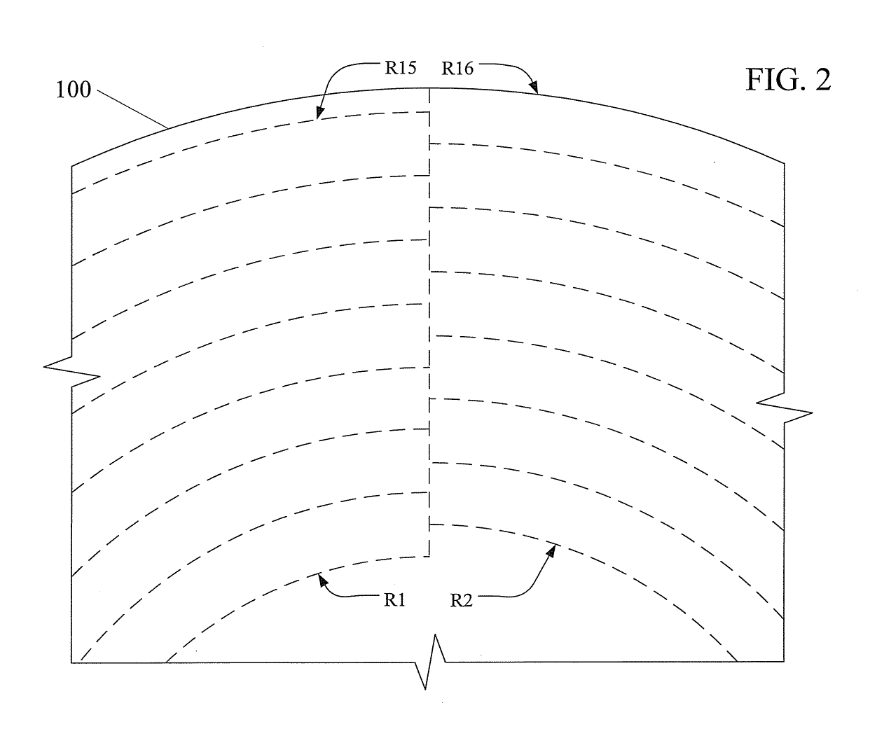

FIG. 2 is a close-up detail view of the wheel protector illustrated in FIG. 1. In the embodiment illustrated in FIG. 2, the ends of the concentric semicircular indicators are connected with other indicators, perforations, or tear-away tabs. In the embodiment illustrated in FIGS. 1 and 2, each indicator is a semicircle (i.e., a circular arc having a central angle θ of 180 degrees), but other embodiments are contemplated, including forming arcs having central angles of 120 degrees, etc. The use of indicators 102 that are shaped like concentric semicircles rather than concentric rings allows shield 100 to be configured to support a greater number of radii or to support radii with a smaller step size while avoiding manufacturing difficulties associated with mass-producing a product with closely-spaced perforations. The embodiment illustrated in FIGS. 1 and 2 also mitigates a problem in which the user intends to tear off a ring of one diameter but accidently tears off a ring of a smaller diameter instead, e.g., because the smaller diameter ring was attached more firmly to the next larger ring than to the next smaller ring. In the embodiment illustrated in FIGS. 1 and 2, each circular arc, starting from the arc having a radius of R1, the arc having a radius of R2, and so on, are staggered relative to each other—e.g., R1 occupies a different angle around the center of the circle than R2 occupies, and so on.

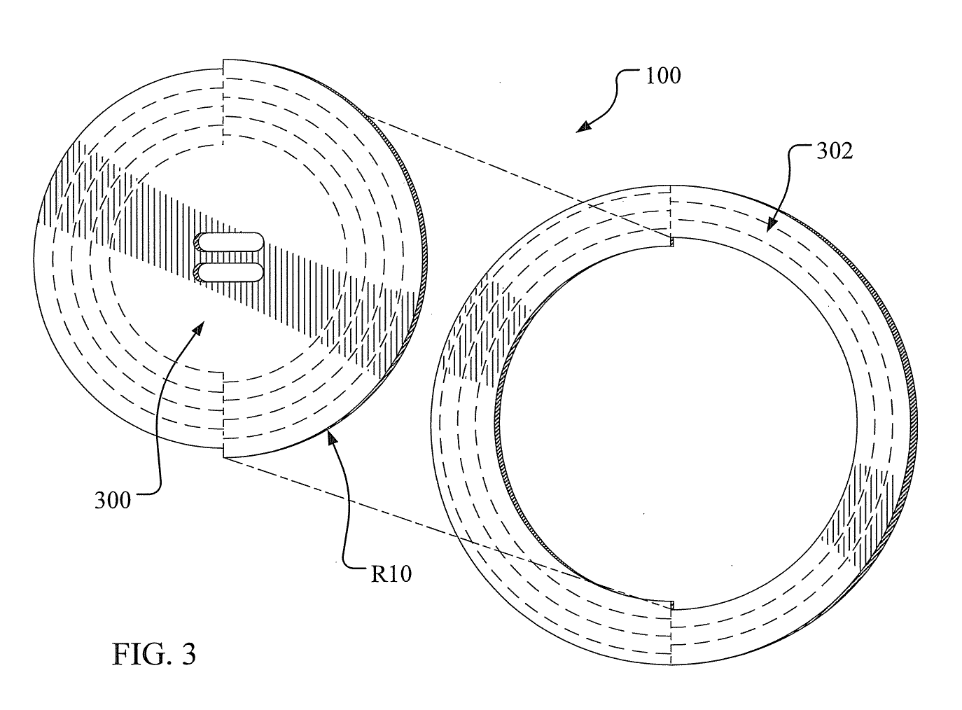

FIG. 3 is a perspective view of a wheel protector according to an embodiment of the subject matter described herein showing the separation along one of the indicators 102 to produce a wheel protector of a desired size. In the embodiment illustrated in FIG. 3, the user has separated shield 100 into two portions: an inner shield 300 having one portion of the desired size (in this example, radius R10), another portion of another size (e.g., radius R9, which may or may not also be a desired size), and the unused remainder 302.

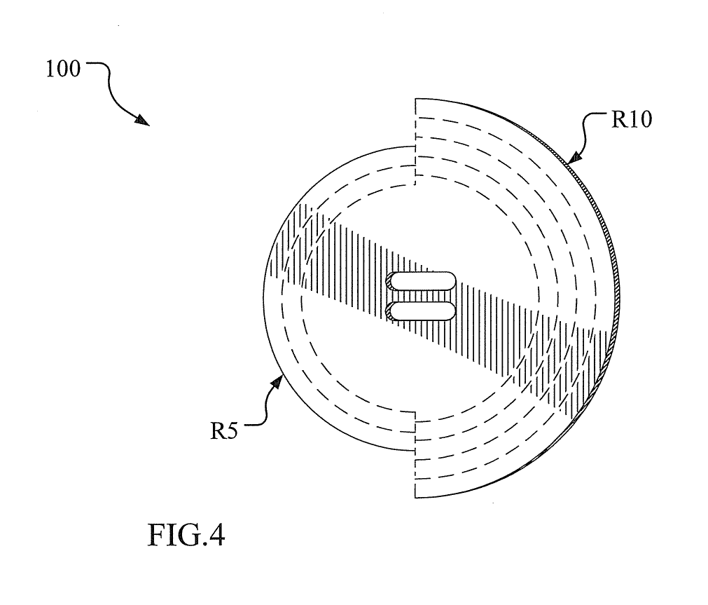

FIG. 4 is a top view of a wheel protector according to an embodiment of the subject matter described herein, illustrating the principle that a single wheel protector 100 may be configured for use with more than one wheel size. In the embodiment illustrated in FIG. 4, wheel protector 100 has been configured to provide a semicircular wheel protector for wheels of a first radius (e.g., R10) and a semicircular wheel protector for wheels of second radius (e.g., R5.)

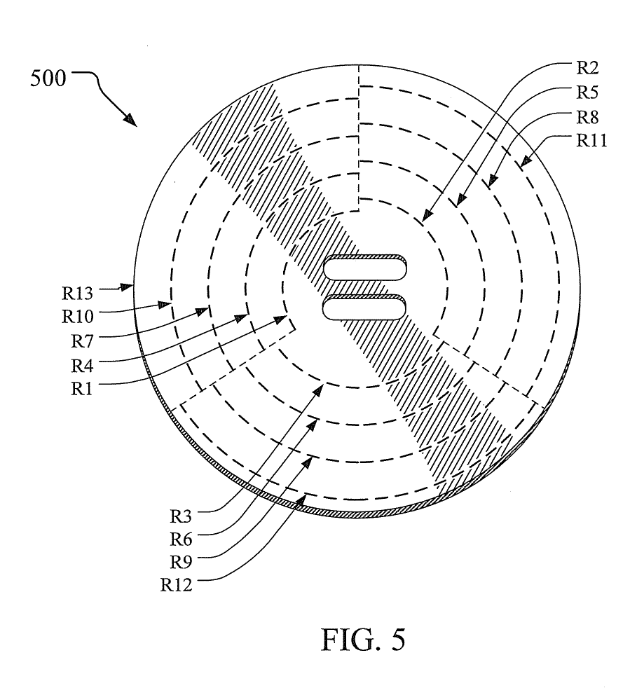

FIG. 5 is a top view of a wheel protector according to another embodiment of the subject matter described herein. The embodiment illustrated in FIG. 5 shows that the principles described herein can be extended so that a single wheel protector may be configurable to have more than two different radii. For example, wheel protector 500 includes indicia that allow a user to produce a wheel protector having a first portion with a first radius, a second portion with a second radius, and a third portion with a third radius. In the embodiment illustrated in FIG. 5, for example, the indicators are a set of concentric, staggered, circular arcs having central angles of 120 degrees, rather than the circular arc have a central angle of 180 degrees as shown in FIG. 4. Thus, wheel protector 500 could be configured for three different radii.

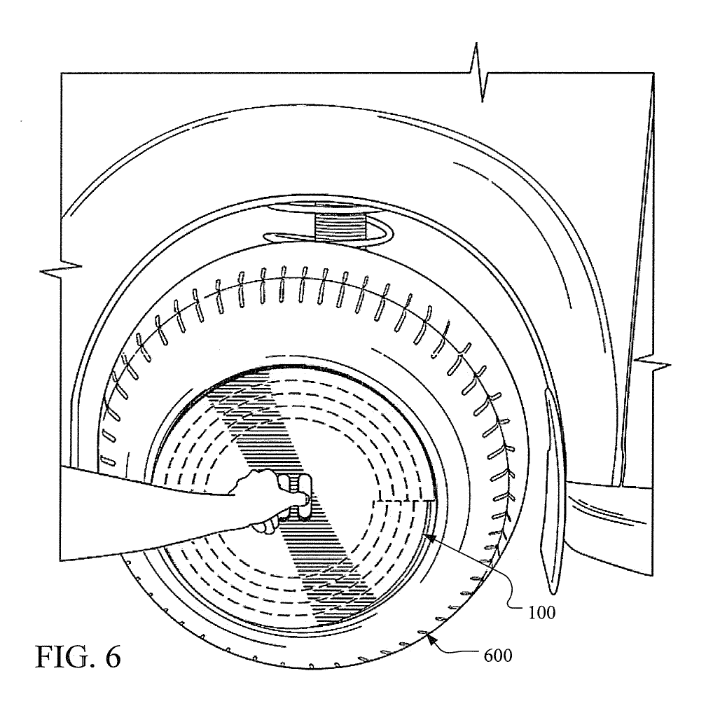

FIG. 6 illustrates a wheel protector according to an embodiment of the subject matter described herein being placed in position for use. In FIG. 6, shield 100 is being placed directly against a tire rim of wheel 600 to guard the rim while the tire is being power washed, cleaned, or chemically treated. The user may thus treat some portion, such as the top half, of wheel 600, rotate shield 100 180 degrees, and then treat another portion, such as the bottom half, of wheel 600.

Shield 100 may protect the tire rim against overspray when the tire is being washed or against chemicals when a harsh chemical cleaner is applied to the tire. Furthermore, shield 100 may be used to protect the rims of automobiles, trucks, golf carts, ATVs, trailers, or any other wheeled vehicle. In one embodiment, shield 100 may be decorated with logos, slogans, advertisements, websites, sports team names, promotions, or other text or artwork.

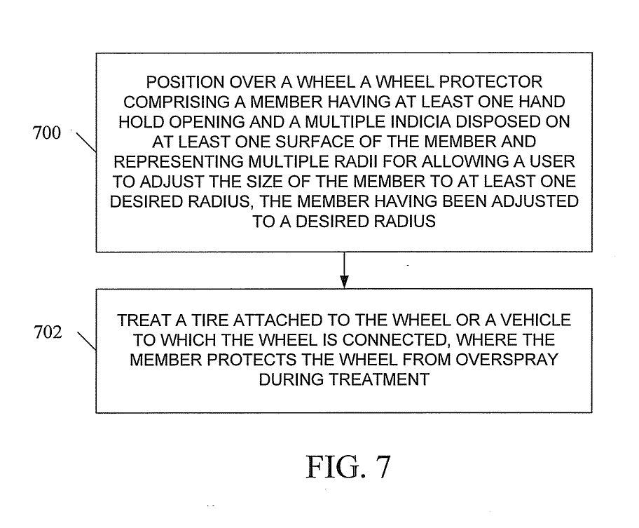

FIG. 7 is a flow chart illustrating an exemplary method for protecting a wheel from overspray during treatment of a tire or vehicle associated with that wheel according to an embodiment of the subject matter described herein. At step 700, a wheel protector that includes a member having one or more hand hold openings and multiple indicia disposed on at least one surface of the member that represent multiple radii for allowing a user to adjust the size of the member to at least one desired radius, the member already having been adjusted to a desired radius, is positioned over a wheel. At step 702, the member protects the wheel from overspray during treatment of a tire attached to the wheel and/or treatment of a vehicle to which the wheel is connected. Treatment of an item may include washing or rinsing the item, or applying a substance to the item. Applying a substance to the item may include applying a cleaner or protectant to the item. Applying a substance to the item may include spraying the substance onto the item. In one embodiment, the member may protect the wheel while the tire is being treated with silicone products, for example, but the member may also protect the wheel while a car or truck to which the wheel is attached is being washed, cleaned, waxed, etc.

In one embodiment, the user places the wheel protector over the wheel and holds it there while the tire or vehicle is being treated. The hand holds may be used for this purpose. In one embodiment, the hand holds may be a set of holes designed to accommodate the user's thumb and/or one or more fingers. Alternatively, the hand-holds may be a pair of slots 104 such as is illustrated in FIG. 1. In one embodiment, the member may have just one hand hold, such as a single hole or a straight or curved slot. In the embodiment illustrated in FIG. 1, hand holds 104 are located at or near the center of the wheel protector, but other positions may be used instead.

In one alternative embodiment, the wheel protector may fit snugly inside the rim such that the user does not need to continue to hold the wheel protector in position during treatment.

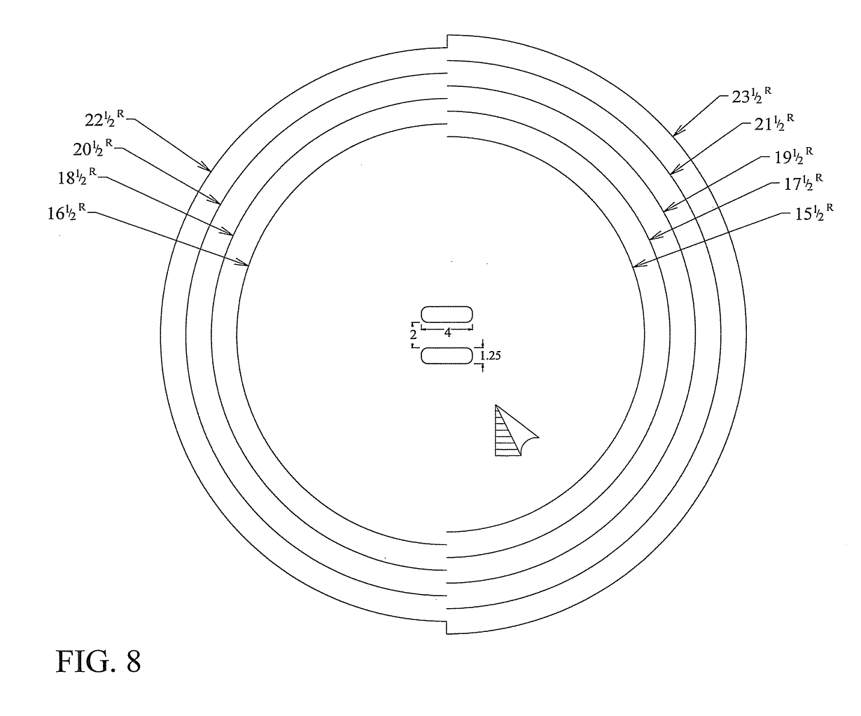

FIG. 8 is a plan view of a wheel protector according to yet another embodiment of the subject matter described herein, showing a variety of radii ranging from 15½ inches to 23½ inches, two finger holes 4 inches long, 1.25 inches wide, and separated by 2 inches.

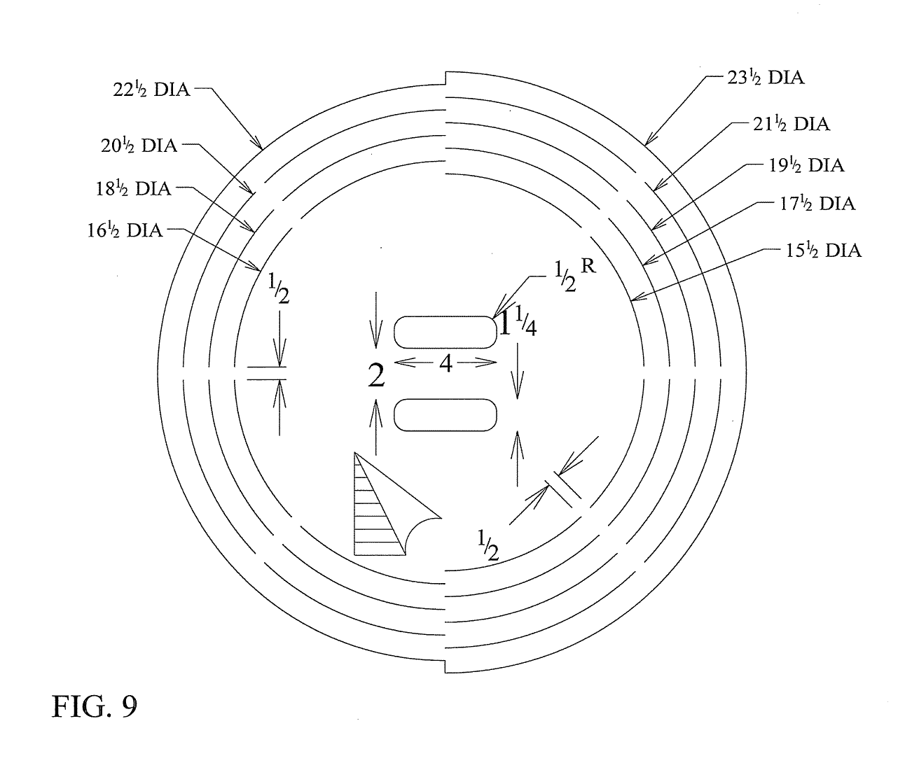

FIG. 9 is a plan view of a wheel protector according to yet another embodiment of the subject matter described herein, showing a variety of diameters ranging from 15½ inches to 23½ inches, where the circular arcs that make up the indicia are split into four approximately 45 degree sectors with a ½ inch space between each sector. This embodiment is suitable for wheel protectors where the indicia represent pre-made cuts through the body material, e.g., the ½ inch spaces between each sector at a particular radius or diameter serve to keep the body pieces together until they are cut by the user in order to remove the unwanted portions of the shield body.

It will be understood that various details, of the subject matter described herein may be changed without departing from the scope of the subject matter described herein. Furthermore, the foregoing description is for the purpose of illustration only, and not for the purpose of limitation.

What is claimed is:

1. An overspray wheel protector, comprising:
a member having at least one hand hold opening and a plurality of indicia disposed on at least one surface of the member, wherein the plurality of indicia comprise a plurality of circular arcs that represent a plurality of radii for allowing a user to remove a first portion of the member such that the remainder of the member comprises a wheel protector having a first portion for protecting a wheel of a first radius and a second portion for protecting a wheel of a second radius.

2. The wheel protector of claim 1 wherein at least one of the plurality of indicia comprises markings on the surface of the member to indicate to a user where to cut the member in order to remove the first portion.

3. The wheel protector of claim 1 wherein at least one of the plurality of indicia comprises perforations at least partially through the thickness of the member to allow a user to cut or tear the member along one or more of the perforations in order to remove the first portion.

4. The wheel protector of claim 1 wherein at least one of the plurality of indicia comprises cuts partially through the thickness of the member to allow a user to cut or tear through a remaining uncut thickness of the member in order to remove the first portion.

5. The wheel protector of claim 1 wherein at least one of the plurality of indicia comprises cuts completely through the thickness of the member to allow a user to cut or tear through an uncut portion of the member in order to remove the first portion.

6. The wheel protector of claim 1 wherein the plurality of indicia represent a plurality of radii corresponding to tire or wheel rim radii.

7. The wheel protector of claim 6 wherein the plurality of indicia represent a plurality of radii corresponding to standard tire or wheel rim radii.

8. The wheel protector of claim 1 wherein at least some of the plurality of indicia comprise a set of nested concentric circular arcs.

9. The wheel protector of claim 8 wherein each of the plurality of nested concentric circular arcs occupies an angle around the center of the circle that is different from the angle around the center of the circle that is occupied by an adjacent concentric circular arc.

10. The wheel protector of claim 9 wherein each of the plurality of nested concentric circular arcs comprise a circular arc having a central angle greater than 0 degrees and less than 360 degrees.

11. The wheel protector of claim 10 wherein at least one of the plurality of nested concentric circular arcs comprises a semicircular arc having a central angle of 180 degrees.

12. The wheel protector of claim 10 wherein at least one of the plurality of nested concentric circular arcs comprises a semicircular arc having a central angle of 120 degrees.

13. The wheel protector of claim 1 wherein the member comprises at least one of: corrugated or un-corrugated plastic, foam board, plastic coated foam board, metal or metallic material, cardboard, coated cardboard, wood, and composite.

14. The wheel protector of claim 1 wherein the member comprises a waterproof or water-resistant material.

15. The wheel protector of claim 1 wherein the member comprises a rigid or semi-rigid material.

16. The wheel protector of claim 1 wherein the member comprises a material that is foldable or rollable.

17. The wheel protector of claim 1 wherein the member is substantially planar.

18. The wheel protector of claim 1 wherein the member is substantially disk-shaped.

19. The wheel protector of claim 1 wherein the at least one hand hold opening is located at substantially the center of the member.

20. The wheel protector of claim 1 wherein the at least one hand hold opening comprises a plurality of openings.

21. A method for protecting a wheel from overspray during treatment of a tire or vehicle associated with the wheel, the method comprising:
positioning over a wheel a wheel protector comprising a member having at least one hand hold opening and a plurality of indicia disposed on at least one surface of the member and representing a plurality of a plurality of radii for allowing a user to remove a first portion of the member such that the remainder of the member comprises a wheel protector having a first portion for protecting a wheel of a first radius and a second portion for protecting a wheel of a second radius, the member configured to at least one desired diameter; and
treating a tire attached to the wheel or a vehicle to which the wheel is connected, wherein the member protects the wheel from overspray during treatment.
